(19) United States
(12) Patent Application Publication
(10) Pub. No.: US 2017/0270324 A1
(43) Pub. Date: Sep. 21, 2017

(54) ASSOCIATING CONSUMER-PROVIDED ASSETS WITH PHYSICAL OBJECTS USING NFC TAGS

(71) Applicant: HALLMARK CARDS, INCORPORATED, KANSAS CITY, MO (US)

(72) Inventors: MAX JEFFERIES YOUNGER, ROELAND PARK, KS (US); SCOTT SCHIMKE, LEAVENWORTH, KS (US); COLLIN GLENN SMITH, SHAWNEE, KS (US)

(21) Appl. No.: 15/461,260

(22) Filed: Mar. 16, 2017

Related U.S. Application Data
(60) Provisional application No. 62/309,642, filed on Mar. 17, 2016.

(51) Int. Cl. G06K 7/10; G06K 19/07

(52) U.S. Cl. CPC G06K 7/10297; G06K 19/0723

(57) ABSTRACT

Systems, methods, and computer-readable storage media are provided for using Near Field Communication (NFC) smart “tags” associated with physical objects in conjunction with NFC-enabled devices to associate digital content with physical assets. Digital content is received that is to be associated with an NFC tag associated with a physical object. In embodiments, such digital content may be provided by a purchaser of a physical asset and may include, by way of example only, photographs, videos, audio files, text files, data files, hyperlinks, and the like that are related to a particular event or occasion. The received digital content is stored, in an online environment, in association with a unique identifier associated with the NFC tag. Upon receiving an indication that the NFC tag has been read by an NFC reader associated with a user device, the digital content is provided for presentation in association with the user device.

### CROSS-REFERENCE TO RELATED APPLICATIONS

This application claims priority to U.S. Provisional Patent Application No. 62/309,642 entitled “Method and System for Associating Digital Assets with Physical Objects Through NFC Tags,” filed Mar. 17, 2016, which is incorporated herein by reference in its entirety.

### BACKGROUND

In today's world, with the rapid increase in available digital content, a desire exists to couple digital assets with physical objects. Finding a way to link physical objects or products to digital content (for instance, photos, videos, audio files, webpages, and the like) such that the technology is not readily visible to the eye or camera is challenging, especially without having to couple a battery to the physical object. Further, users do not have an easy way to digitally connect their smart devices to consumer goods, Point-of-Purchase displays in retail locations, or other tangible artifacts. While some products and technologies exist that allow one to connect the digital world to the physical world, such products and technologies have their shortcomings.

For instance, one prior art method of associating digital content with physical objects is the use of visual codes, e.g., Quick Response (QR) codes, or other image recognition tools. Such methods require manufacturers to place image recognition indicators directly onto an associated product, which often detracts from its appearance. It further does not provide a straightforward way by which a consumer may retrofit a product to include an image recognition indicator and/or associate personalized digital content with a product.

Another prior art method is the use of a technology such as Bluetooth, Bluetooth Low Energy (BLE), or Bluetooth Smart to connect wirelessly. Such technology is not only expensive, but also requires the associated product to be fitted with a battery-powered mechanism to interact with a smart device.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In various embodiments, systems, methods, and computer-readable storage media are provided for using Near Field Communication (NFC) smart “tags” associated with physical objects in conjunction with NFC-enabled devices (e.g., smart phones, tablets, etc.) to associate digital content with physical assets. Digital content is received that is to be associated with an NFC tag associated with a physical object. In embodiments, such digital content may be provided by a purchaser of a physical asset and may include, by way of example only, photographs, videos, audio files, text files, data files, hyperlinks, and the like that are related to a particular event or occasion. The received digital content is stored, in an online environment, in association with a unique identifier associated with the NFC tag. Upon receiving an indication that the NFC tag has been read by an NFC reader associated with a user device, the digital content is provided for presentation in association with the user device. A software application or “app” also may be used in conjunction with NFC-enabled devices to provide enhanced features and capabilities.

### BRIEF DESCRIPTION OF THE DRAWINGS

The present invention is illustrated by way of example and not limitation in the accompanying figures in which like reference numerals indicate similar elements and in which:

FIG. 1 is a schematic diagram of a high level flow chart illustrating an exemplary method in accordance with embodiments of the present invention;

FIG. 2 is a schematic diagram of a high-level infrastructure, architecture, and/or system in which embodiments of the present invention may be employed;

FIGS. 3A-3C collectively illustrate a schematic diagram showing an exemplary method in accordance with embodiments of the present invention;

FIG. 4 illustrates an exemplary implementation of the present technology wherein an NFC tag is associated with a child's toy or ornament, in accordance with embodiments of the present invention;

FIG. 5 illustrates another exemplary implementation of the present technology wherein an NFC tag is associated with a greeting card, in accordance with embodiments of the present invention;

FIGS. 6 and 6A-6C are schematic diagrams that collectively illustrate an exemplary overall method of the present technology, in accordance with embodiments of the present invention;

FIGS. 7 and 7A-7C are schematic diagrams that collectively illustrate an exemplary method for scanning NFC tags in accordance with embodiments of the present invention;

FIGS. 8 and 8A-8C are schematic diagrams that collectively illustrate an exemplary method for associating digital assets or “product memories” with a physical object, in accordance with embodiments of the present invention;

FIGS. 9 and 9A-9C are schematic diagrams that collectively illustrate an exemplary method for establishing product settings, in accordance with embodiments of the present invention;

FIG. 10 is a schematic diagram of a flow chart illustrating an exemplary method for setting and/or adjusting app settings, in accordance with embodiments of the present invention;

FIG. 11 is a schematic diagram of a flow chart illustrating an exemplary method for linking products, in accordance with embodiments of the present invention;

FIGS. 12, 12A and 12B collectively illustrate a schematic diagram of a flow chart showing an exemplary method for inviting users to view digital content associated with a product via an NFC tag, in accordance with embodiments of the present invention;

FIGS. 13-16 are exemplary screen shots that may be utilized in accordance with embodiments of the present invention; and

FIG. 17 is a block diagram of an exemplary computing environment suitable for use in implementing embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed to systems, methods, and computer-readable storage media for using Near Field Communication (NFC) smart “tags” associated with physical objects in conjunction with NFC-enabled devices (e.g., smart phones, tablets, etc.) to associate digital content with physical assets. In embodiments, such digital content maybe provided by a purchaser of a physical asset and may include photos, videos, audio files, text files, data files, hyperlinks, and the like that are related to a particular event or occasion. Accordingly, in some embodiments, such digital content may be referred to herein as “digital memories,” “digital assets,” “event bookmarks” or “occasion bookmarks.” A software application or “app” also may be used in conjunction with NFC-enabled devices to provide enhanced features and capabilities.

NFC is a wireless radio communication standard and an ever increasing number of smart devices include NFC “readers” that can generate and send out a radio frequency (RF) field. NFC smart tags have a radio chip with storage memory and an antenna. They are passive, meaning they do not have to have a battery or power source. They, instead, are powered by an RF field generated by the users' smart device through magnetic induction. The smart tags then transmit data stored in their memory to the NFC reader via the antenna. The NFC reader receives the signal and the data. NFC smart tags, NFC readers, and their respective operations are known in the art and their operation and functionality is within the knowledge of one of ordinary skill in the art. Accordingly, NFC smart tags, NFC readers, and their respective operations are not further described herein.

Various aspects of the technology described herein make use of NFC technology to allow purchasers of physical objects to associate personalized digital content with the physical objects. In particular embodiments, the physical objects may be associated with particular events or occasions (e.g., birthdays, holidays, milestone events, weddings, etc.) and include smart tags associated therewith. In embodiments, an app operates in conjunction with the basic NFC technology to enhance its functionality and the user experience.

In exemplary implementations wherein a user's NFC-enabled device does not include an installed app, the user may place their NFC-enabled device (e.g., phone, tablet, or the like) in close proximity to an NFC tag (i.e., they “tap” their device to the tag). As will be understood and appreciated by those having ordinary skill in the relevant art, such “tap” does not require a physical touching of the device to the tag but rather a “hover” in proximity thereto is sufficient. Upon recognition, the tag will cause a hyperlink to be transmitted to the device and a webpage associated with the hyperlink will be opened, for instance, in a browser. The webpage includes digital content or assets associated therewith that can be experienced by the user. By way of example and not limitation, the content may include a marketing video for the product or an NFC-associated app and/or a link to download the app. As discussed in greater detail below, if the tag has public permissions enabled, the user may be permitted to add additional digital content to the webpage, whereby the next time the tag is read by an NFC-enabled device, the newly added digital content also will be displayed. In embodiments, if the tag has appropriate public permissions enabled, the user may be permitted to replace the digital content associated with an NFC tag with their own desired content, effectively overriding the prior content. Thus, the next time the tag is read by an NFC-enabled device, the newly added digital content will be displayed in place of the prior content. Any and all such variations, and any combination thereof, are contemplated to be within the scope of embodiments of the present invention.

In exemplary implementations wherein a user's NFC-enabled device includes an installed app, a user can “tap” their NFC-enabled device to the tag and use the app to assign digital content (e.g., photos, videos or other digital media) to the tag. This in essence turns the physical object into a real world “bookmark” or an object with digital content (for instance, “digital memories” or “digital assets”) associated therewith. In embodiments wherein the digital content is associated with an event or occasion, the physical object effectively becomes an “event bookmark” or “occasion bookmark,” whereupon when the digital content is accessed, reminders of the occasion are presented. In embodiment, the user can then associate additional content with the tag through the app without having to tap the device another time. In some implementations, the user may be permitted to update or edit already-associated digital content as well.

In accordance with embodiments of the present invention, NFC-enabled tags may be embedded in and/or on products used as in-store marketing/awareness, product tutorials, in-store displays, or even used in way-finding. In such embodiments, when a tag is read by an NFC-enabled device, the device presents pre-associated content that is stored in association with a local or cloud database for the tag.

Users of the app can also personalize a tag by associating digital content of their own creation. Such information may be associated, for instance, through a cloud database. Associated information may include anything from a game associated with a product, a video for marketing the product, a tutorial on how to use the product, or photographs taken while using the product. The personal content (or “memories”) a user associates with a tag also may be cloud-linked to the tag and accessible by others only if they have appropriate permissions.

In implementations, users may associate personal content (such as, pictures, videos, audio files, text files, websites, or other digital media) with an NFC tag. When the tag is read using an NFC-enabled device (e.g., a cellular telephone), the device may present the associated content for experiencing by the user. If a user so chose, and the tag were appropriately enabled, the user may be permitted to share a tag's content privately (e.g., via e-mail or text message) or share it with another user publicly, for instance, by sharing a link via text message, e-mail, social media or another digital means. In embodiments, information associated with a single tag may be copied by a user's account and associated with multiple tags so that all of the tags result in presentation of the same content. This would allow, by way of example and not limitation, a groom to give gifts to his groomsmen that each has a tag associated therewith. When any of the groomsmen tap their gift with their NFC-enabled device, digital content from a website, such as photographs of the wedding or a message personally thanking them for their participation in the momentous day, may be presented in association with their device.

In embodiments, tags also may have content pre-associated therewith, for instance, content already associated at the time of purchase of the physical object with which the tag is associated. Such content may include, by way of example only and not limitation, content created by the manufacturer of the product in association with which the tag is embedded. One particular example would be an ornament created by Hallmark®. When the user taps their NFC-enabled device (e.g., cellular telephone) to the ornament, a video showing the artist creating the ornament may be initiated in association with their device.

In some instances, a user also may transfer digital content into and out of a tag that has capacity. For instance, a user may wirelessly transfer a recorded message into a tag embedded in a greeting card with sound playing capabilities by tapping their NFC-enabled phone and sending the audio from their phone directly into or onto the tag associated with the product. The tag may be cloud-linked but also could be experienced without access to the cloud if the tag has the digital audio file stored locally in the memory of the tag. The audio file also could be transferred into separate storage memory associated with the product in conjunction with appropriate software and circuitry to transfer data.

In an exemplary embodiment, in use, when a user “taps” an NFC-enabled device to a tag, the device sends out a signal that powers and makes the tag readable. The device reads the data on the tag embedded or otherwise placed in association with a product or store display, for instance. The data references a database (e.g., stored in the cloud) where pre-associated content is associated with an identifier for that tag. If no app is installed on the device, the user is sent (for instance, via NFC Smart Poster Record Type Definition) to a website containing the associated digital content. If the smart device has an appropriate app installed, when the user “taps” the smart device to the tag, the device displays the associated content in association with the smart device in the context of the app. Content may include, by way of example only and not limitation, pictures, videos, audio files, text files, games, or other digital content, or hyperlinks to webpages having any of the same. Users may associate their own content with a “tag” by assigning it and storing the content either locally or in the cloud. A particular user's tags can be shared with other users of their choosing, through means such as email, text message, social media, and the like. A tag's content also may be shared socially with groups or the general public if permissions are enabled in association with the product and/or the user.

As such, in accordance with implementations of the present invention, users can associate or embed digital content in association with physical objects, thereby turning a physical object into a bookmark for their memories. Those memories can be for personal use, shared from person to person, shared from person to groups, or made publically available.

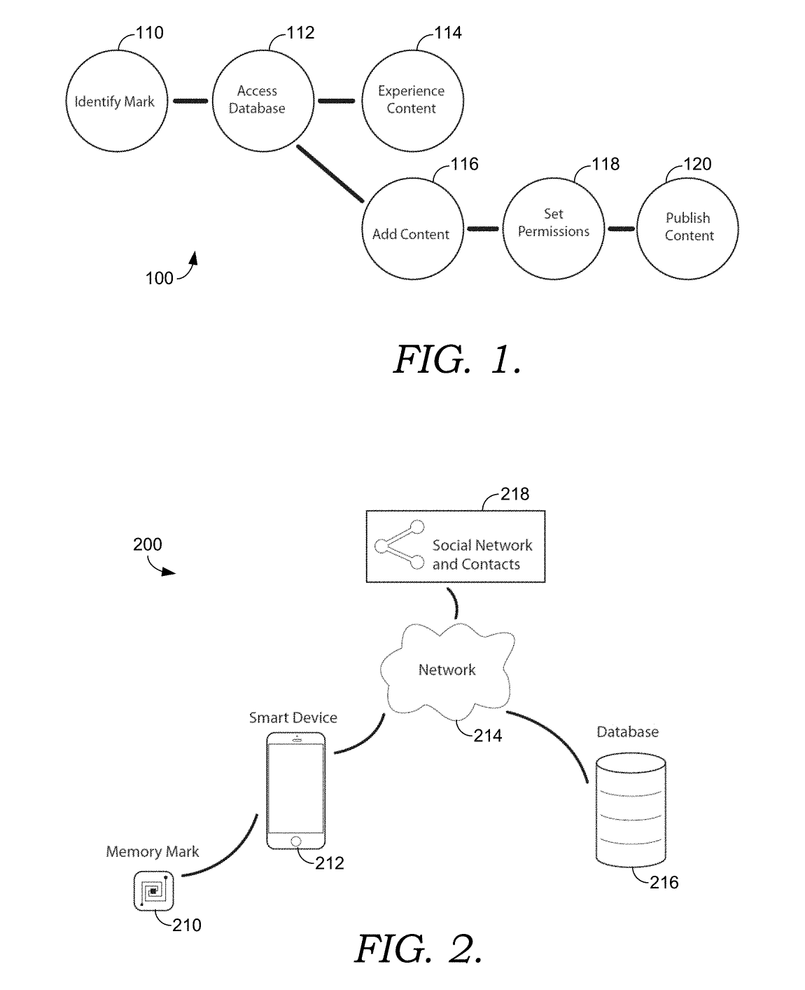

Referring now to the drawings, and initially to FIG. 1 in particular, a schematic diagram is provided illustrating a high level flow chart of a method 100, in accordance with exemplary embodiments of the present invention. Initially, as indicated by reference numeral 110, a user identifies an NFC-identifier or tag and taps his or her NFC-enabled device to the tag. As indicated at 112, the NFC-enabled device includes an NFC reader that reads the information associated with the tag and is directed to a database (e.g., a local or cloud database) where digital content associated with the tag is stored and may be accessed. The user then either may experience the content, as indicated at 114, such as by viewing a webpage or digital media stored in the database, or the user may add content, as indicated at 116, such as digital files, to the database to be associated with the tag. If the user adds content to the database, the user also may be permitted to set permissions regarding other users that may access the content. This is indicated at 118. The user then may publish the content according to those permissions, as indicated at 120.

With reference now to FIG. 2, illustrated is a schematic view of an exemplary high-level infrastructure, architecture, and/or system 200 in which embodiments of the present invention may be employed. The system 200 includes a Memory Mark or NFC tag 210 that is readable by a smart device 212 having an associated NFC reader. The smart device 212 is configured to access a network 214 (e.g., the Internet, a LAN, etc.) which, in embodiments, may be referred to simply as the “cloud.” Networks and network architectures are known to those having ordinary skill in the relevant art and, accordingly, the network 214 is not further described herein. A database 216 associated with the network 214 is configured to store digital content and provide access thereto. In exemplary embodiments, the database 216 may be configured to store NFC-tag identifiers and associated digital content references in a look-up table. In such embodiments, upon receiving an indication that a tag has been read, a unique identifier (UID) for the tag is looked up in the look-up table and digital content associated with the UID is accessed and presented (upon verification of appropriate user permissions). As illustrated, a social network 218 is associated with the cloud for sharing the content stored in the database 216 or on the tag 210, if so desired (and if appropriate permissions are associated with the at least one of the user, the content and the tag).

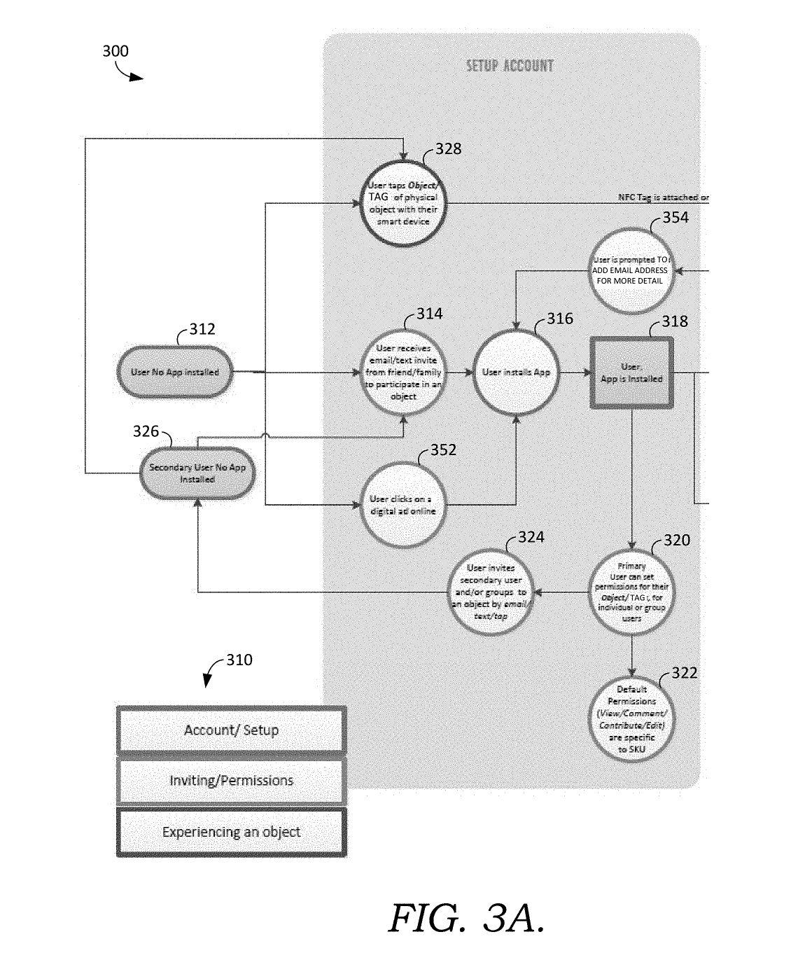

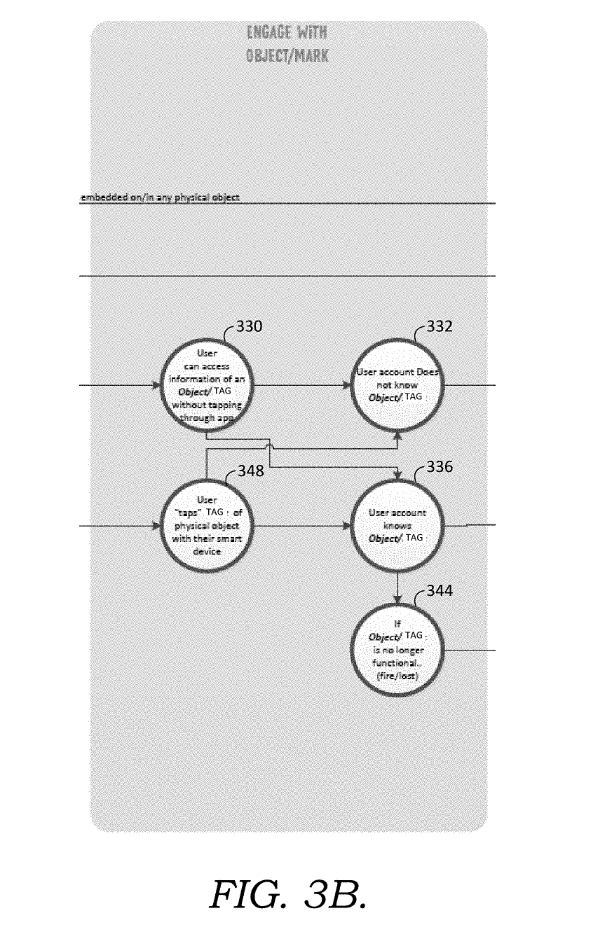

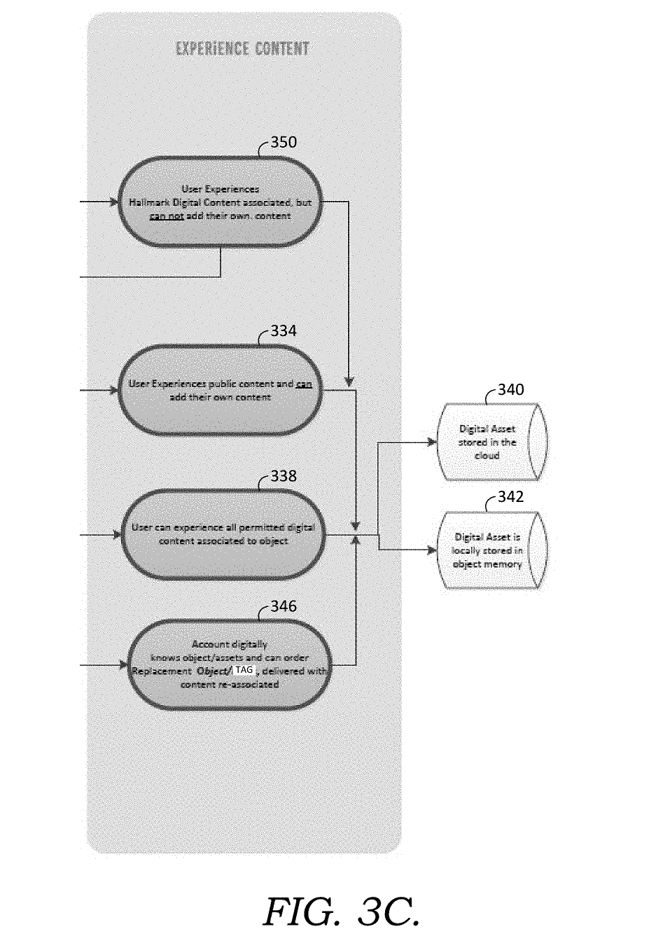

FIGS. 3A-3C collectively illustrate a schematic diagram showing a flow chart of an overall method 300 in accordance with embodiments of the present invention. The flow chart has been broken across three pages for ease of viewing but can be “stitched” together to view the entire flow by placing 3A (illustrating NFC account setup) on the left, 3B (illustrating engagement with an object and/or NFC tag) in the middle, and 3C (illustrating a user's experience with the content) on the right. With initial reference to FIG. 3A, and in particular the legend 310 illustrated at the bottom left thereof, it can be seen that steps are illustrated that are associated with account set up procedure (i.e., steps 312, 316, 318 and 326), steps associated with inviting and giving permissions related to the digital content (i.e., steps 314, 320, 322, 324, 352 and 354), and steps associated with experiencing the digital content (i.e., steps 328, 330, 332, 334, 336, 338, 344, 346, 348 and 350).

Starting with an instance where the user has no app installed 312 in association with their NFC-enabled device or otherwise, the user may receive an email or text invite from a friend or family member to experience an object 314 (i.e., view digital content). The user may then be invited to and install the app 316. Once installed 318, if the user is the primary user, they may choose to set permissions for an object (i.e., digital content) or mark (i.e., tag) for individuals or groups of users 320. The permissions may have default arrangements 322 regarding viewing that are specific to particular tags or to a particular product (for instance, identified by a SKU). The user also may choose to invite secondary users or groups 324 to view digital content by e-mail, text, and/or social media. In such an instance, the request would be sent to a secondary user that may not yet have the app installed 326. The secondary user may be invited to and may install the app 314/316 (as with the original user above) or they may experience the content directly without the app by tapping the tag of the physical object directly with their own NFC-enabled device 328.

If the user has the app installed, we see in FIG. 3B that the user can access digital information associated with the tag 330 without tapping through the app. If the user account does not recognize the tag 332 (i.e., the user account does not have permission to access the content), the user (as can be seen in FIG. 3C) may be permitted to experience the public content and can add their own content 334. If the user account does recognize the tag or digital media 336 (i.e., the user account does include permission to access the content), the user (as can be seen in FIG. 3C) can experience all permitted digital content associated with an object and can add their own content 338. In each of these instances, the digital assets can be stored in the cloud 340 or may be stored locally in the tag or product's memory 342. If the user has permission but the tag is no longer functional 344, the app can order a replacement tag or product with the tag and can re-associate the content with the replacement tag/object 346.

With reference back to FIG. 3B, we see that the user with the app installed can also access content by tapping the tag of the physical object with their NFC-enabled device 348. In such an instance, the flow chart illustrates, and the app provides, that the user is provided with content according to whether or not the user has the appropriate permissions (e.g., in accordance with steps 336 and 338 if the user account does not recognize the object/tag or steps 332 and 334 if the user account does recognize the object/tag), as discussed above.

With reference back to the instance where the user does not have the app installed and they tap the tag of the physical object directly with their own smart device 328, we see in FIG. 3C that the user experiences, in this embodiment, content pre-created by the manufacturer of the product and pre-associated with the tag in the product 350 (in this case the manufacturer is Hallmark®). The user, not having permission or the app, cannot add their own content to the tag (i.e., stored on the cloud and associated with the tag). Referring back to FIG. 3A, the user may be prompted to register 352, provide their e-mail address 354 (or other identifying information required for registration), and/or download the app.

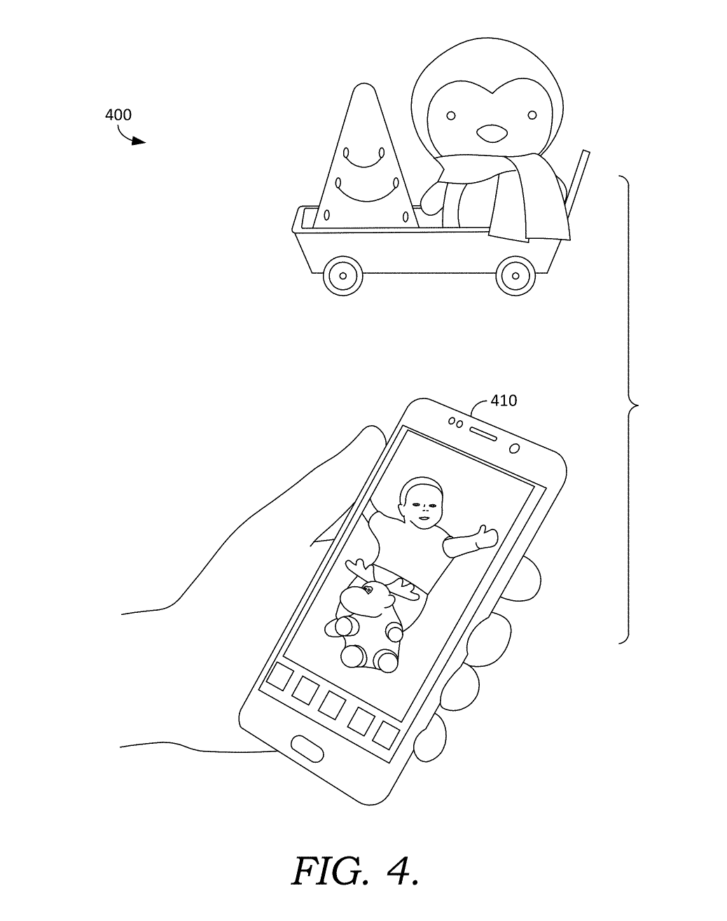

FIG. 4 illustrates an exemplary implementation in accordance with embodiments of the present invention wherein an NFC tag is associated with a child's toy or ornament 400. As illustrated, the object or product 400 is a Christmas ornament entitled “Baby's 1st Christmas.” The ornament 400 has a tag (not shown) embedded in association therewith. In practice, a user (e.g., a parent) may tap their NFC-enabled device (e.g., cellular telephone) 410 to the ornament 400. As a result, the app is activated and the user may associate a photograph of their child (or other digital content) with the tag. The photograph then may be stored, for instance, in association with the cloud. In a future time instance, when the user taps their phone 410 to the ornament 400, the tag may direct the telephone 410 to open the page and the photograph of the child at their first Christmas (or other digital content) may be presented. If the user set the permissions accordingly, another family member or friend visiting the location of the physical object may tap their NFC-enabled device to the ornament 400 resulting in presentation of the same associated photograph. The other family member or friend need not have the app installed on their device to view the photograph. In this manner, a digital photograph or memory is associated with the physical object 400 and with a related occasion or event.

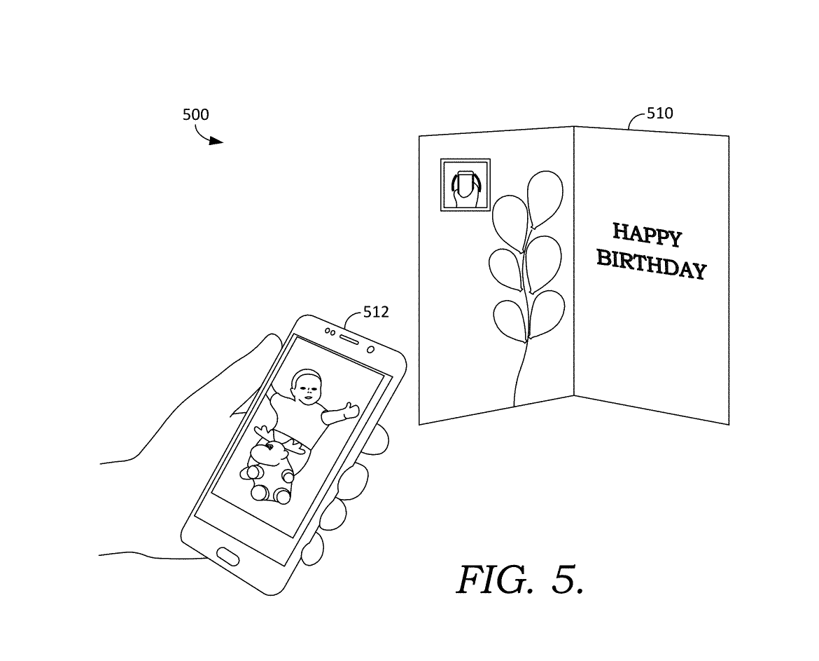

FIG. 5 illustrates another exemplary implementation in accordance with embodiments of the present invention wherein an NFC tag 500 is embedded in the front panel of a greeting card 510. In accordance with the illustrated implementation, a purchaser of the greeting card 510 may tap the tag 500 with their NFC-enabled device 512 (e.g., cellular telephone) and, with the app, associate photographs with the tag 500 embedded in the card 510. The photographs may be stored, for instance, in a database in the cloud. The purchaser may subsequently mail or otherwise deliver the greeting card 510 to an intended recipient. The recipient may open the greeting card 510 and read the same. The recipient also may tap their own NFC-enabled device (not shown) to the card and be directed to a webpage or app that displays the photographs uploaded in association therewith by the purchaser. In embodiments, the purchaser also may associate other types of digital content with the tag 500 (e.g., an audio message that is played on the recipient's phone, a video, music, a game, etc.).

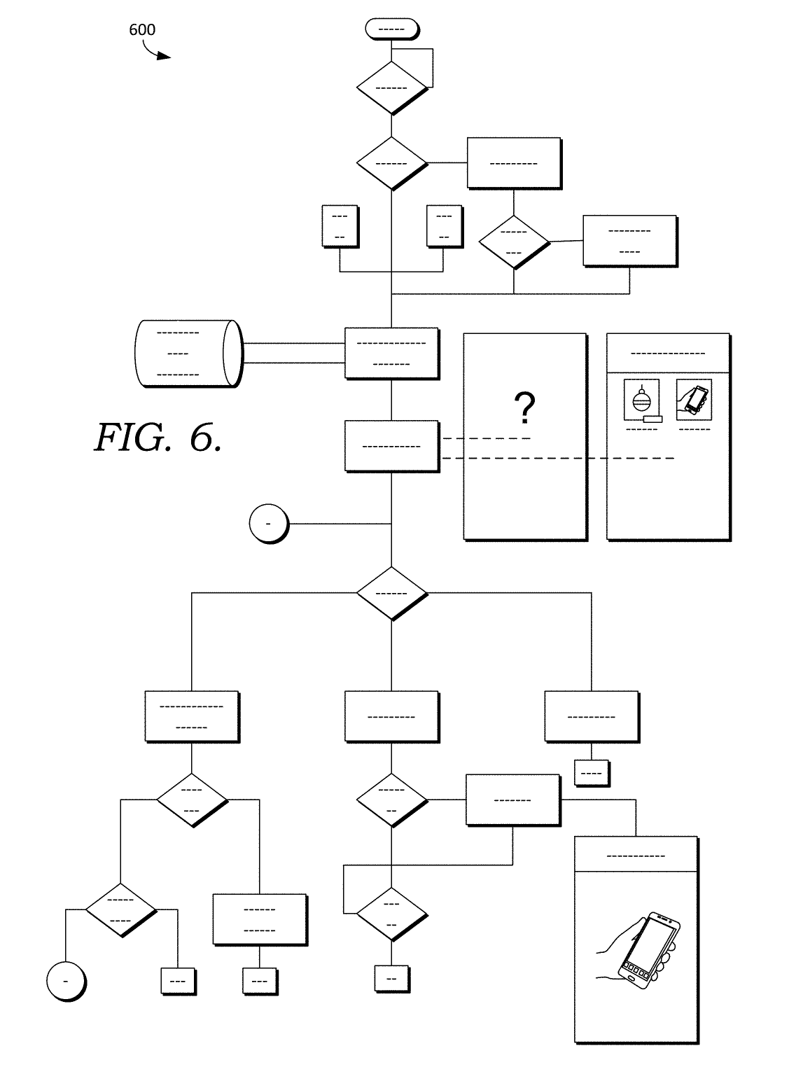

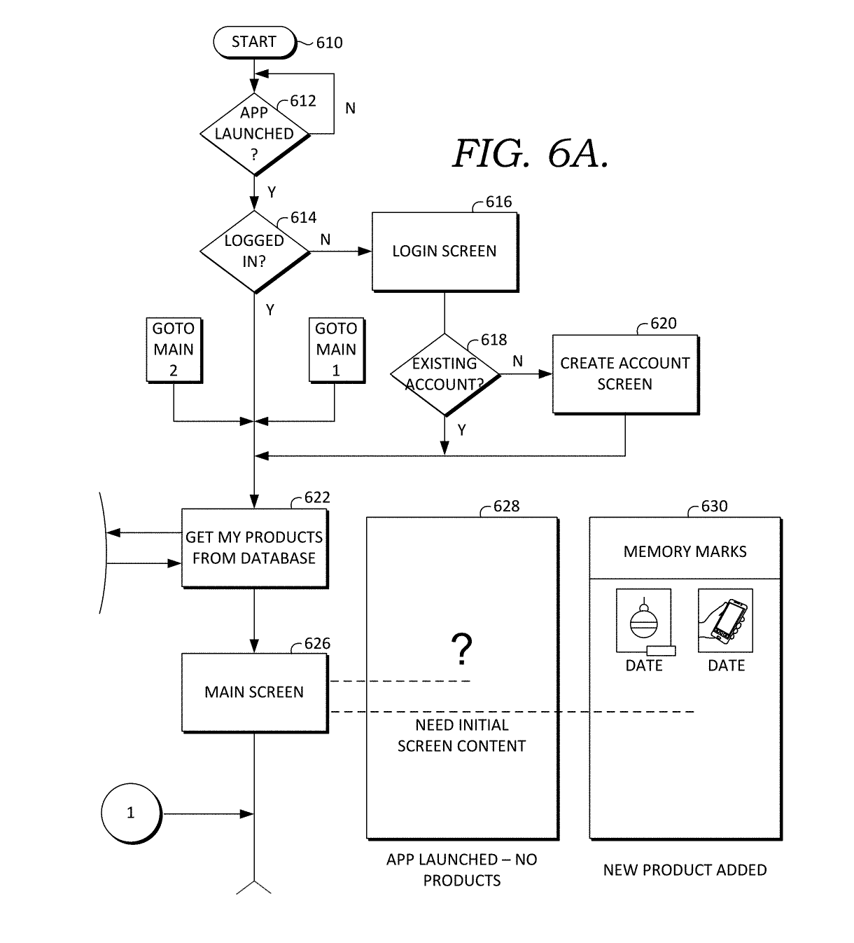

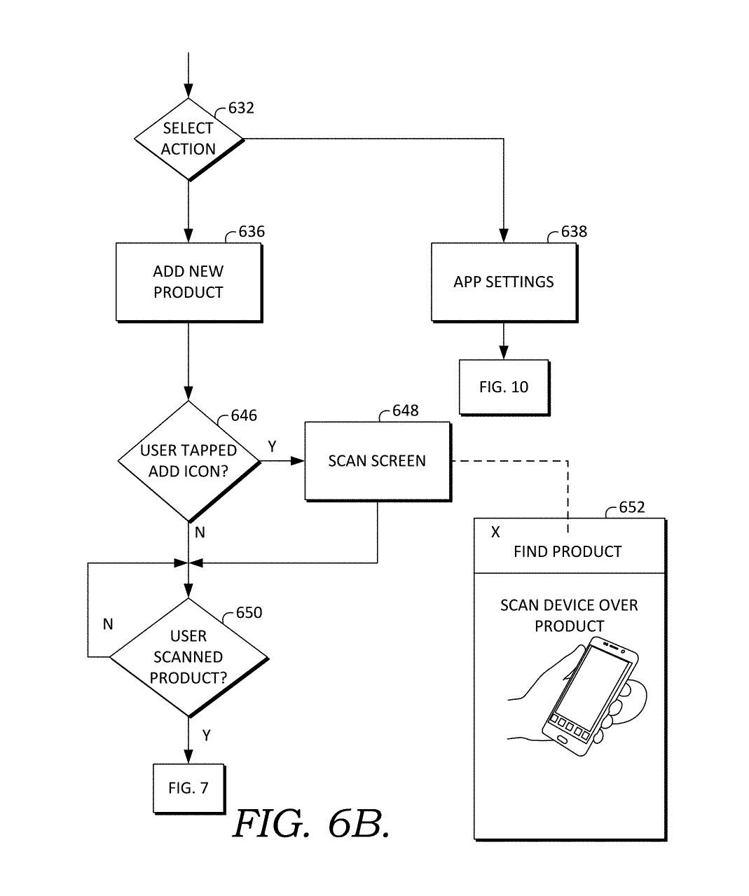

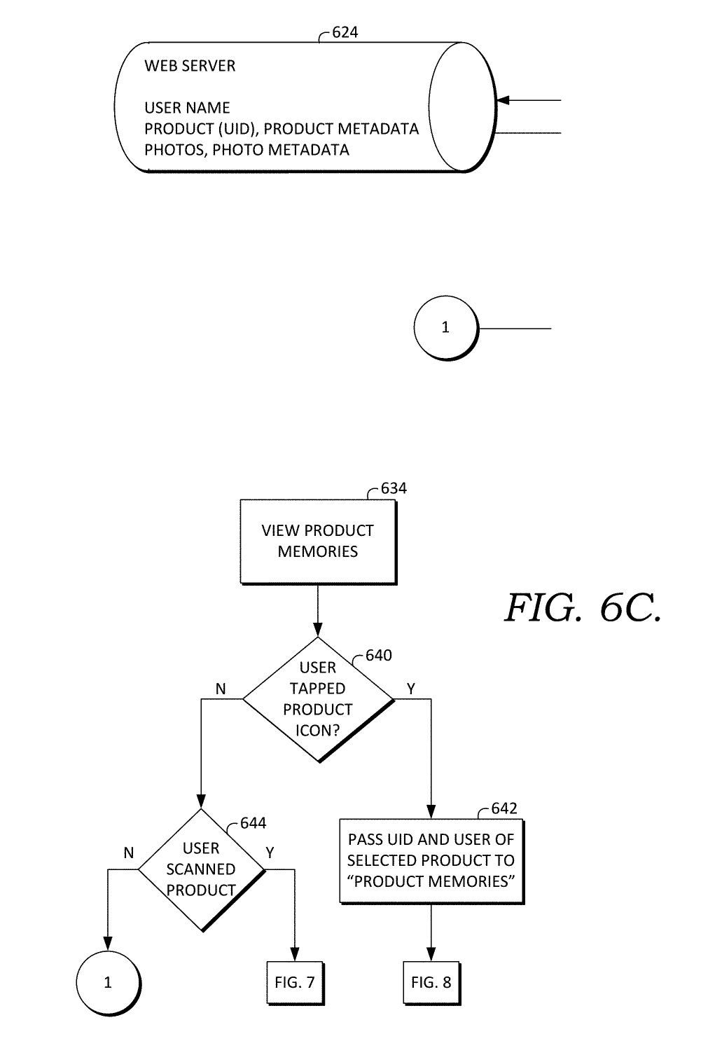

FIGS. 6-12 are schematic diagrams of flow charts illustrating steps performed by a user, through an app, in accordance with exemplary methods of the present invention. The FIGS., like discussed above with respect to FIGS. 3A-3C, have been broken into multiple parts for ease of viewing.

FIGS. 6 and 6A-6C collectively illustrate the primary operation of an app, in accordance with exemplary embodiments of the present invention. FIG. 6 shows the entire exemplary method 600. FIGS. 6A-6C each shows a portion of the method 600 of FIG. 6 a bit larger, for ease of viewing. To reconstruct (or “stitch” back together), FIG. 6B is to be placed immediately beneath FIG. 6A, and FIG. 6C is to be placed to the left of FIG. 6B.

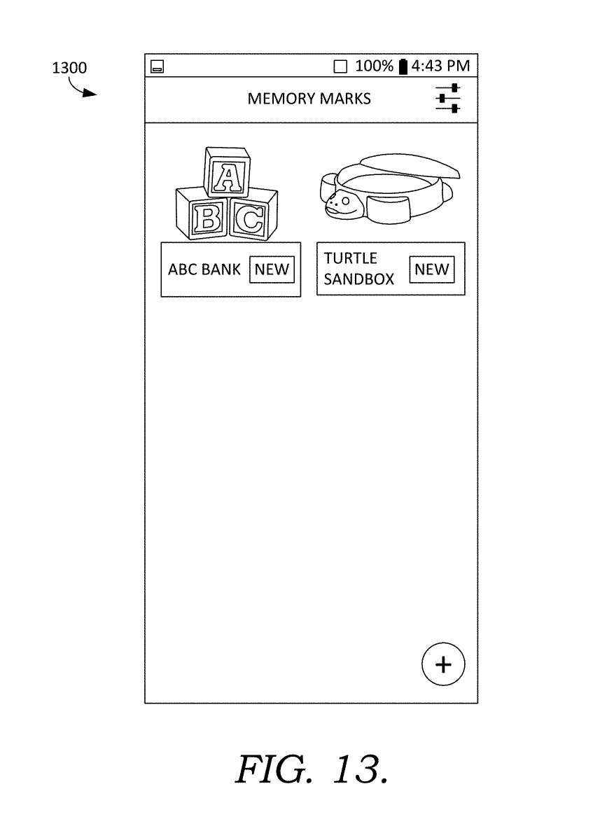

The method 600 begins at step 610. Initially it is determined whether the app is launched 612. If it is, the method proceeds to step 614. If it is not, the user is instructed to launch the app and then it is determined at step 614 whether the user is logged in to the app. If the user is logged in, the method proceeds to step 618. If the user is not logged in, they are presented with a login screen 616. It is next determined if the user has an existing account 618. If they do not have an existing account, the user is prompted to create one 620. In this regard, the user may retrieve digital content 622 from a database 624 and then be presented with the main screen 626. If the user does have an existing account, the method proceeds directly to reference numeral 626. If the user does not have any products with tags embedded therein that are associated with their account, the main screen is blank 628 and they may add products to their account 630. If they already have products in their account, the main screen displays the products (see FIG. 13, as an example) and they may select the product for which they want to control the content associated therewith.

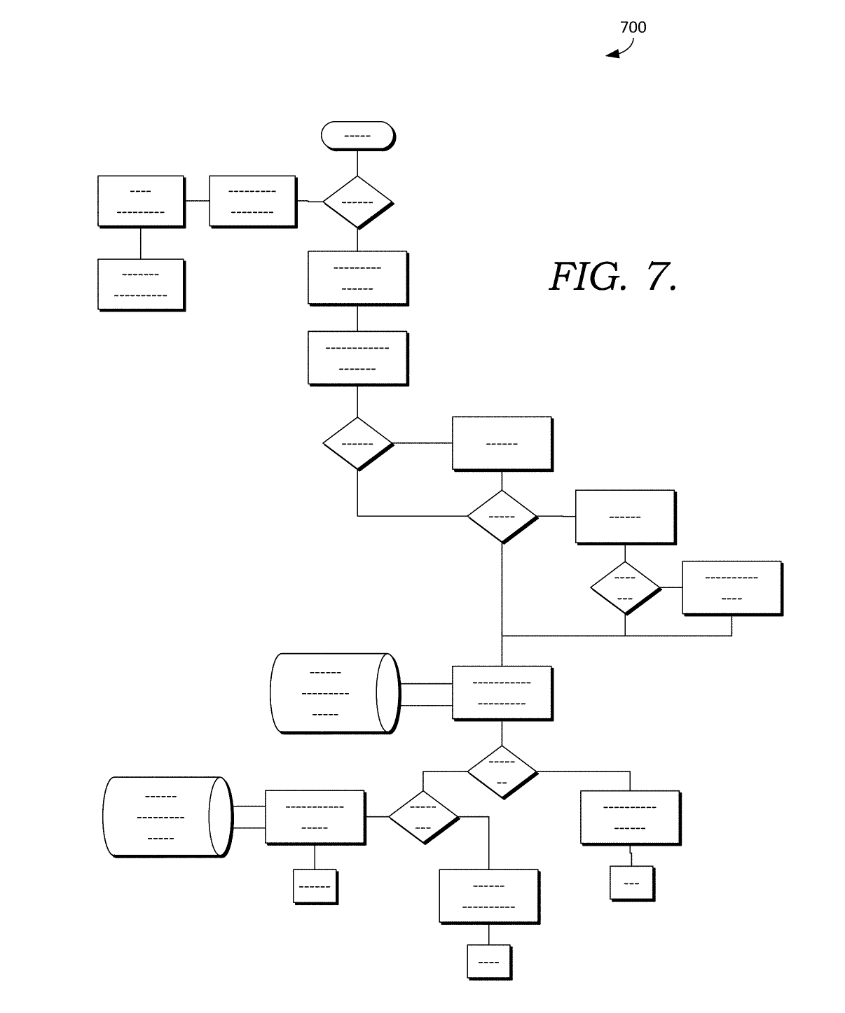

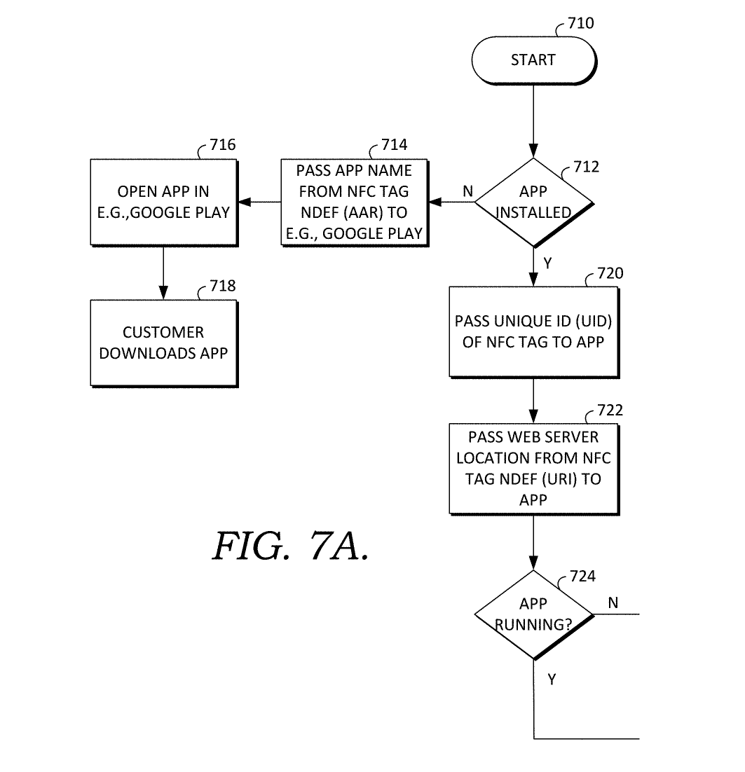

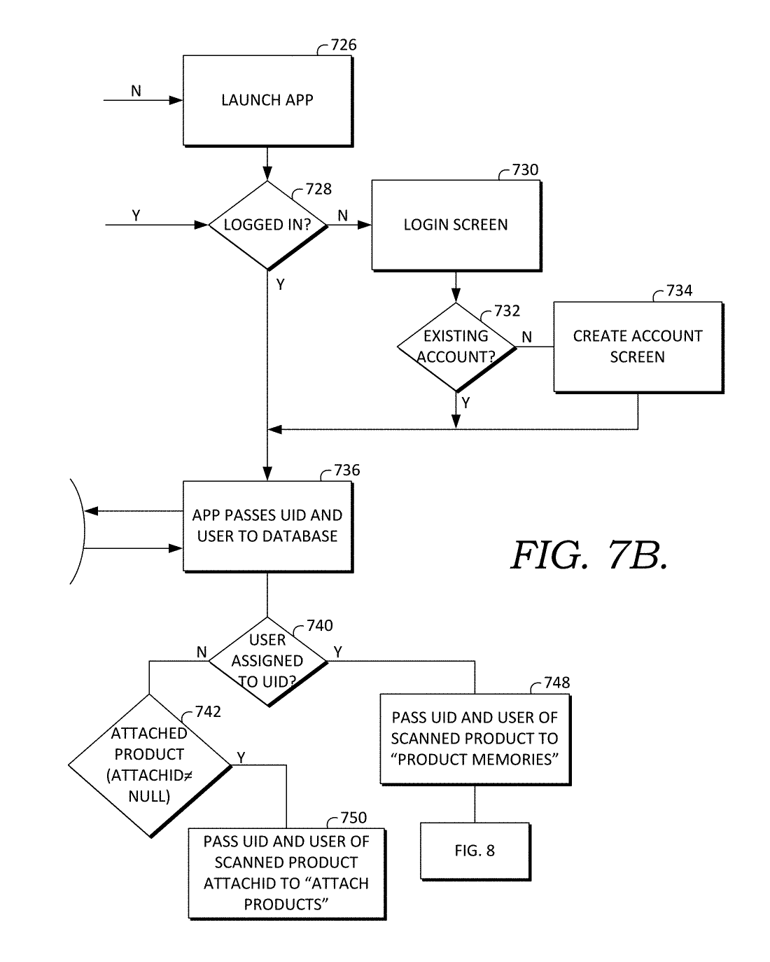

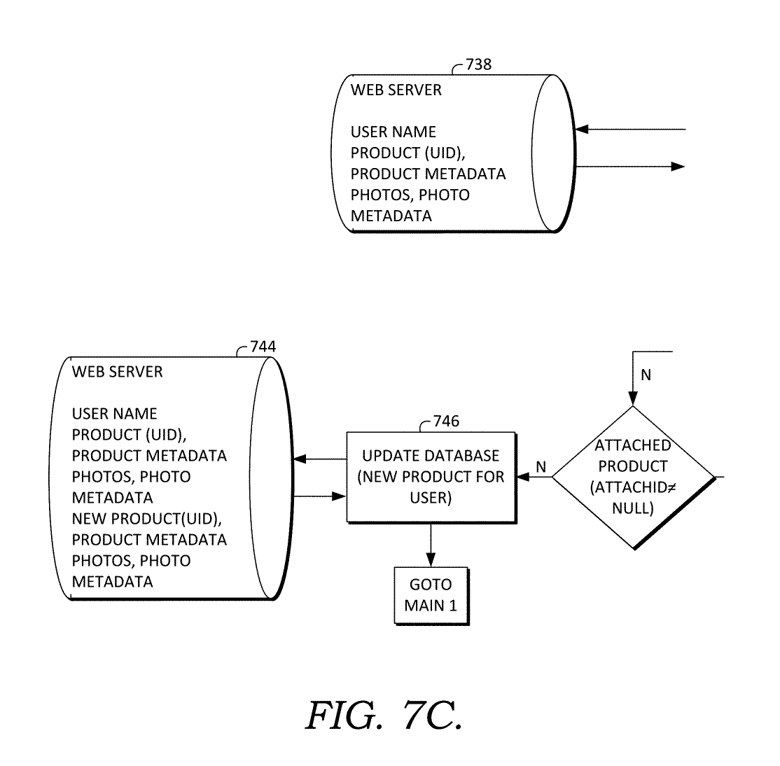

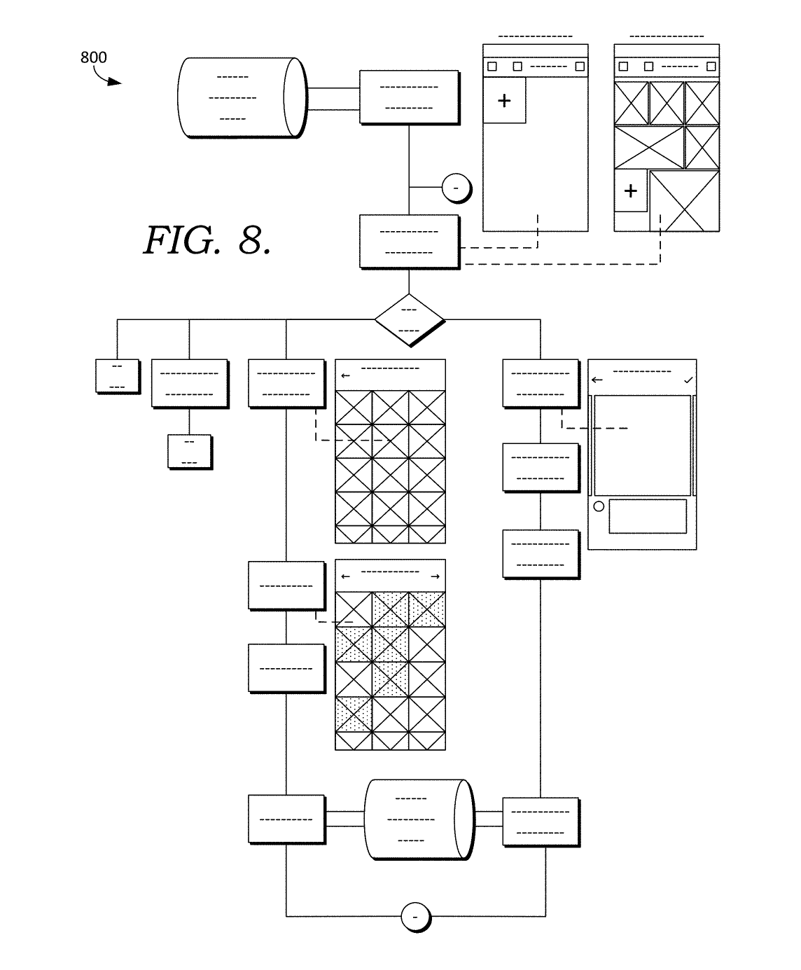

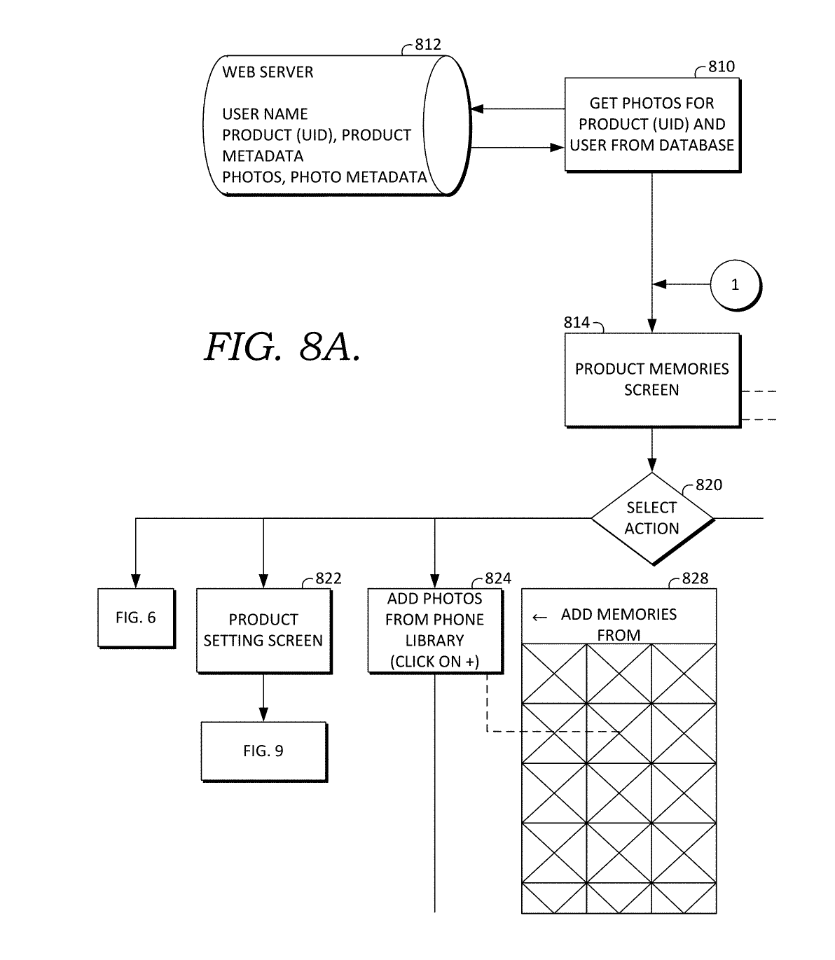

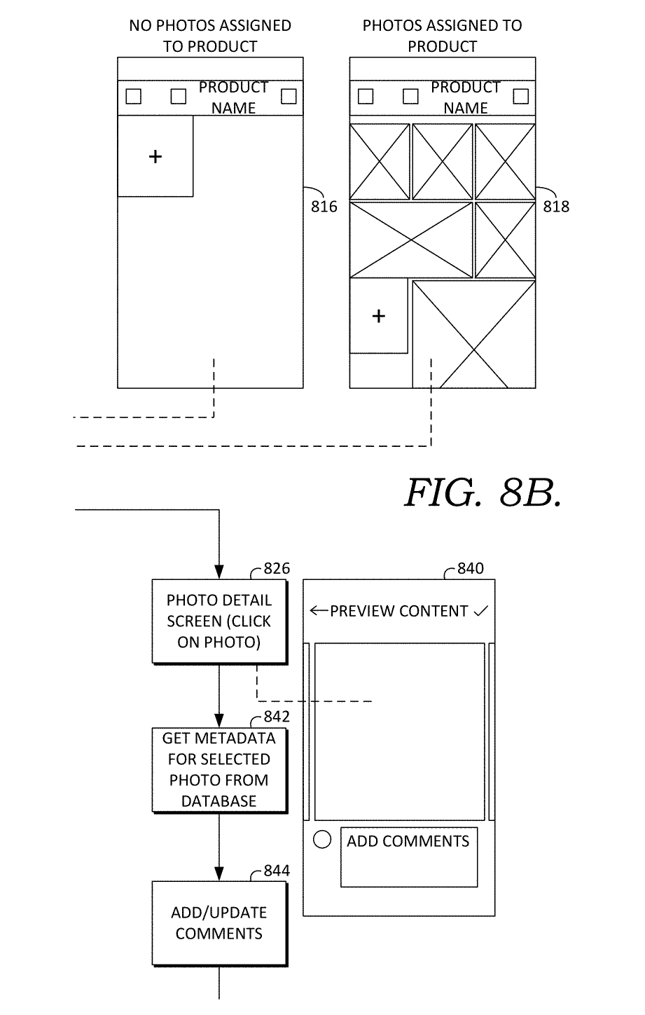

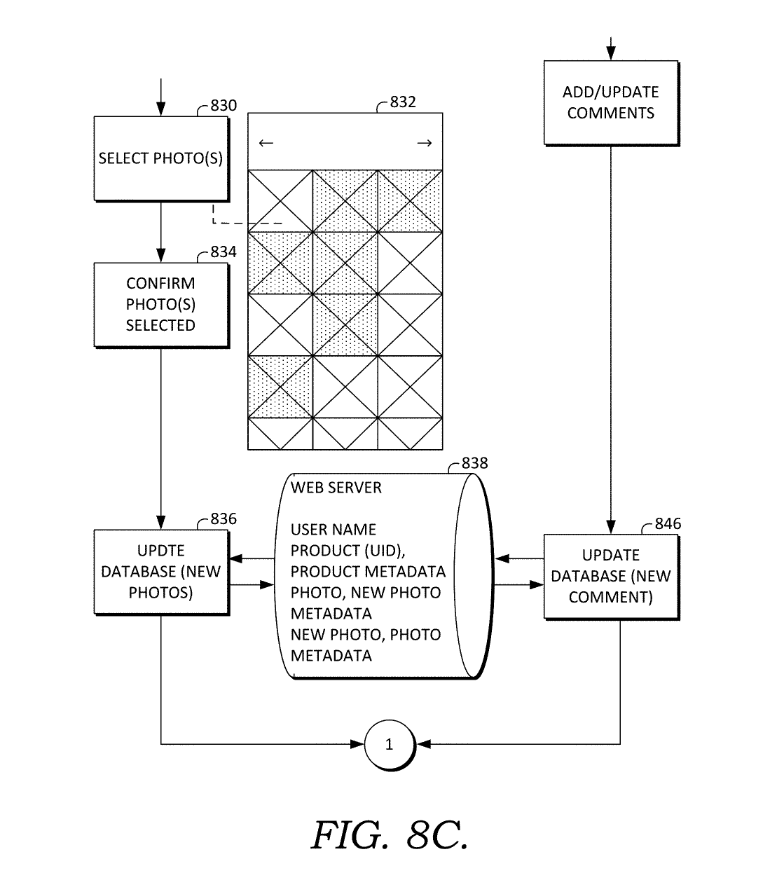

At this point the user may select an action 632. The action may be to view product memories 634, add a new product 636, or control the settings of the app 638. If the user selects to view product memories 634 and taps a product icon 640, a unique identifier (UID) associated with the tag in the product and the user are directed to the Product Memories flow chart illustrated in FIG. 8. If the user selects to view product memories 634 and does not touch a product icon but instead scans a product 644 (i.e., places an NFC-enabled device in close proximity to a desired product so the NFC reader reads the associated tag), the user is directed to the Scan flow chart illustrated in FIG. 7.

If the user selects to add a new product 636 and they touched the “add” icon 646, a “scan” screen 652 is presented 648. If the user then scans the product 650, the user is directed to the Scan flow chart illustrated at FIG. 7. If, however, the user selects to add a new product 636 but does not select the add icon screen but instead scans a product 650, the user will still be directed to the Scan flow chart illustrated at FIG. 7.

If the user selects to control the app settings 638, the user is directed to the App Settings flow chart illustrated at FIG. 10.

FIGS. 7 and 7A-7C are schematic diagrams that collectively illustrate an exemplary method 700 for scanning an NFC tag, in accordance with embodiments of the present invention. FIG. 7 shows the entire exemplary method 700. FIGS. 7A-7C each shows a portion of the method 700 of FIG. 7 a bit larger, for ease of viewing. To reconstruct (or “stitch” back together), FIG. 6B is to be placed beneath and to the right of FIG. 7A, and FIG. 7C is to be placed to the left of FIG. 7B, slightly lower than completely aligned.

The method 700 begins at 710. Initially, it is determined if the app is installed 712. If the app is not installed, the user is direct to an online location where they may acquire the appropriate app (such as from Google Play or the Apple App Store) 714, 716, 718. If the app is installed, the unique identifier (UID) associated with the tag is passed to the app 720. The web server location from the NFC tag (i.e., the Uniform Resource Identifier (URI)) is also passed to the app 722. It is then determined if the app is running 724. If the app is not running, it is launched 726. It is then determined if the user is logged in 728. If the user is not logged in, the user is provided with a login screen 730. It is then determined if the user has an existing account 732. If the user does not have an existing account, they are presented with a “create account” screen 734. Once the user is logged in with an existing account the app passes 736 the UID and the user to a database 738. It is then determined if the user is assigned to the UID 740. If the user is not assigned to the UID, they are instructed to add the product to the account 742 and the database 744 may be updated 746. If the product is already added 748, the user is directed to the Link Products flow chart illustrated at FIG. 11. If the user is assigned to the UID, the UID and the user are directed 750 to the Product Memories flow chart illustrated at FIG. 8.

FIGS. 8 and 8A-8C are schematic diagrams that collectively illustrate an exemplary Product Memories method 800 in accordance with embodiments of the present invention. FIG. 8 shows the entire exemplary method 800. FIGS. 8A-8C each shows a portion of the method 800 of FIG. 8 a bit larger, for ease of viewing. To reconstruct (or “stitch” back together), FIG. 8B is to be placed to the right of FIG. 8A, and FIG. 8C is to be placed beneath FIG. 8A and slightly right of center.

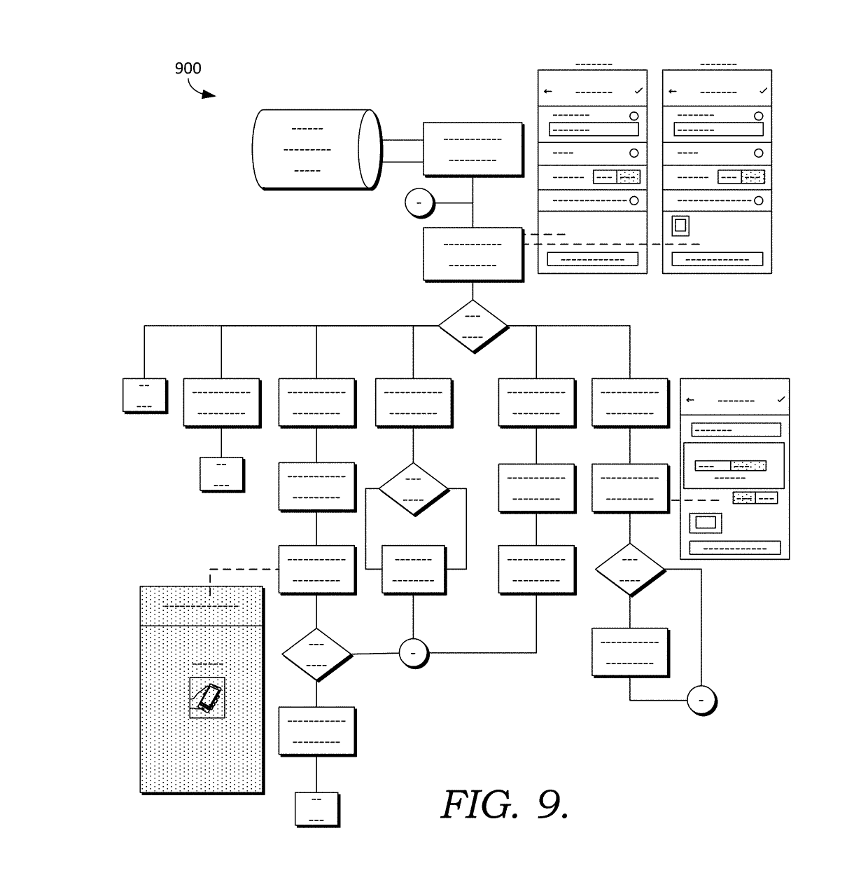

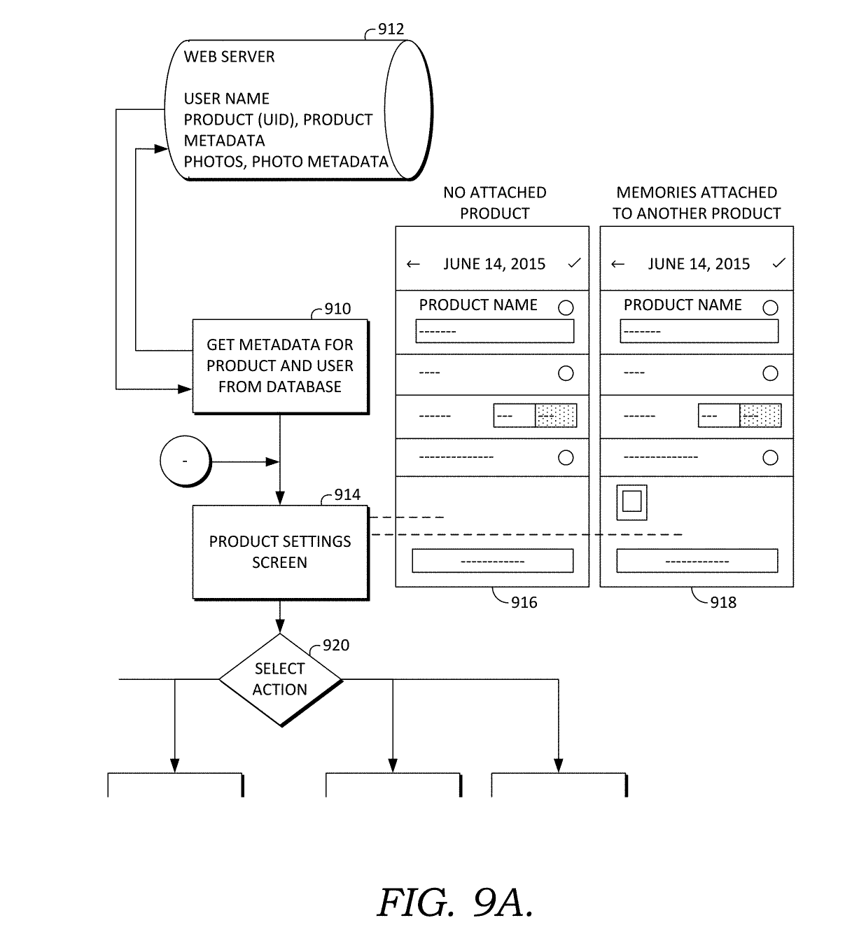

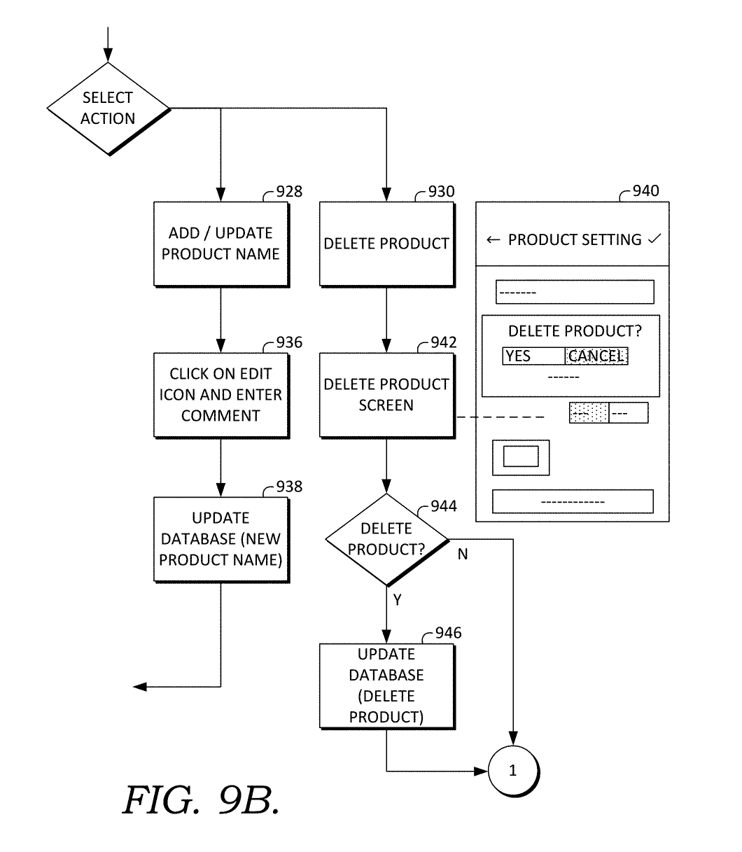

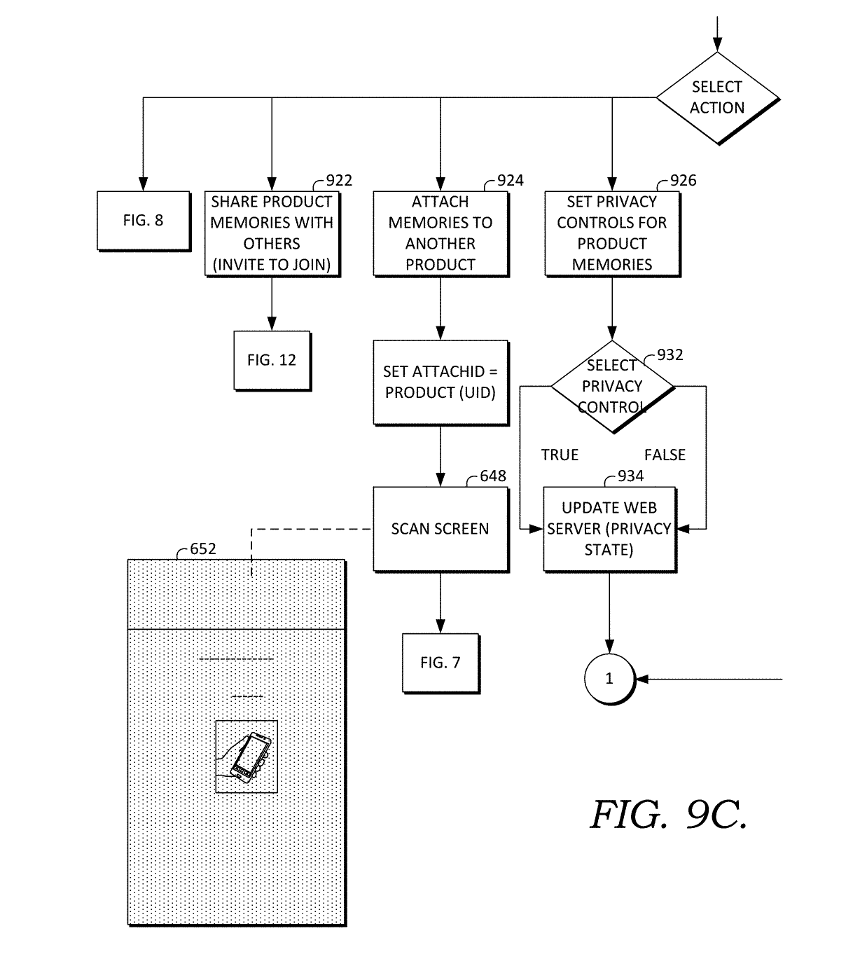

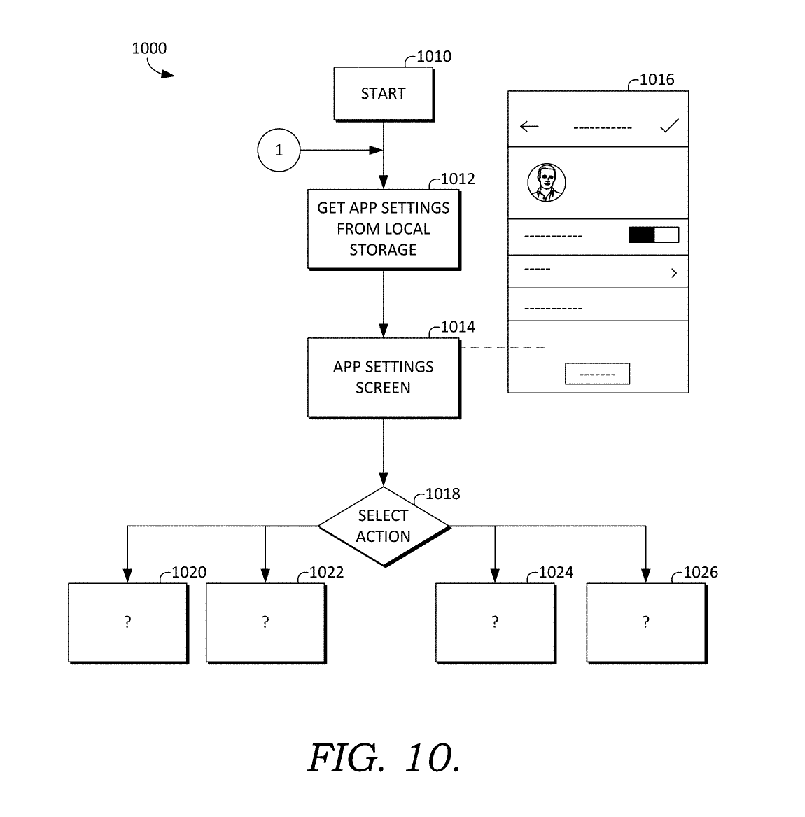

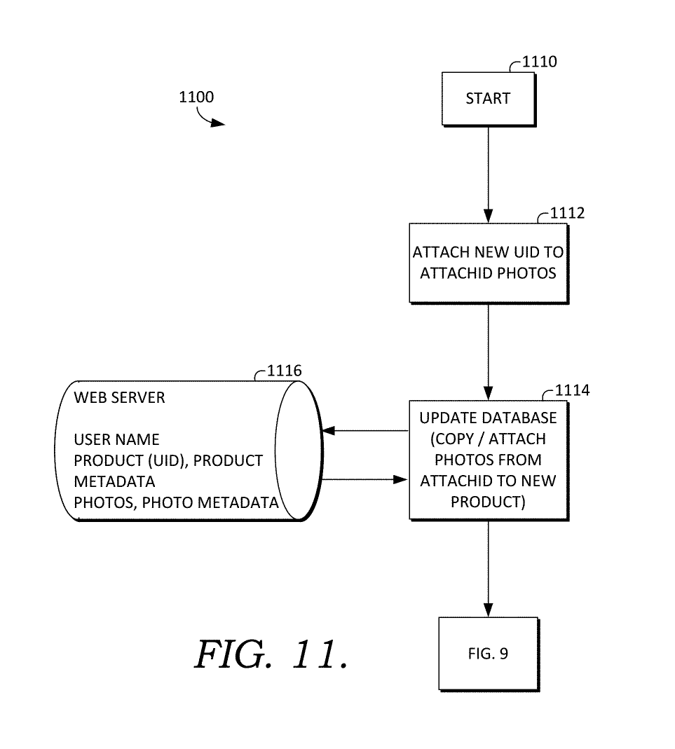

In the initial step 810, photographs (or other digital content) associated with the product are acquired from an online database 812. The user is then presented with a product memories screen 814. The screen will either have no photos assigned to the product 816, or, if the user has already assigned photos to the product, the screen will include photos that have already been associated with the product 818. The user then selects an action 820. The available options are: going to the main screen (FIG. 6), going to the product settings screen 822 (FIG. 9), adding photos from the device (e.g., phone) library 824 and 826, or clicking on a photo already assigned to the product 828.

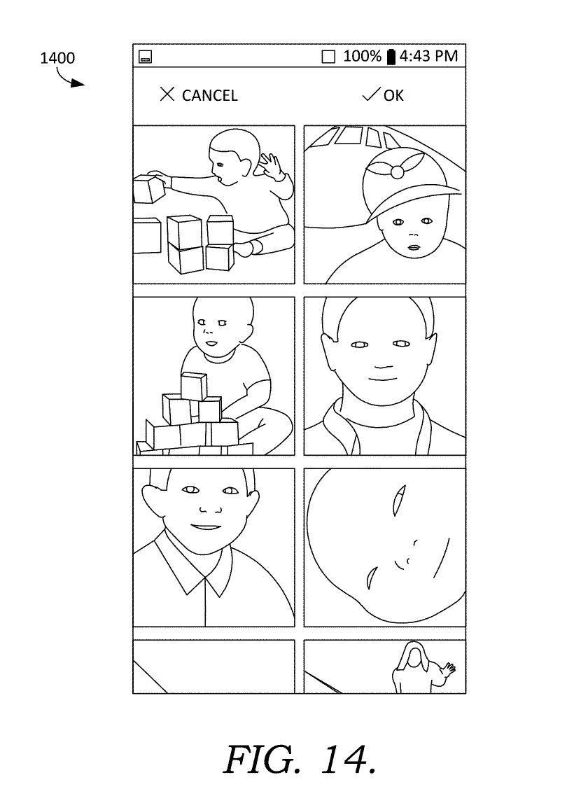

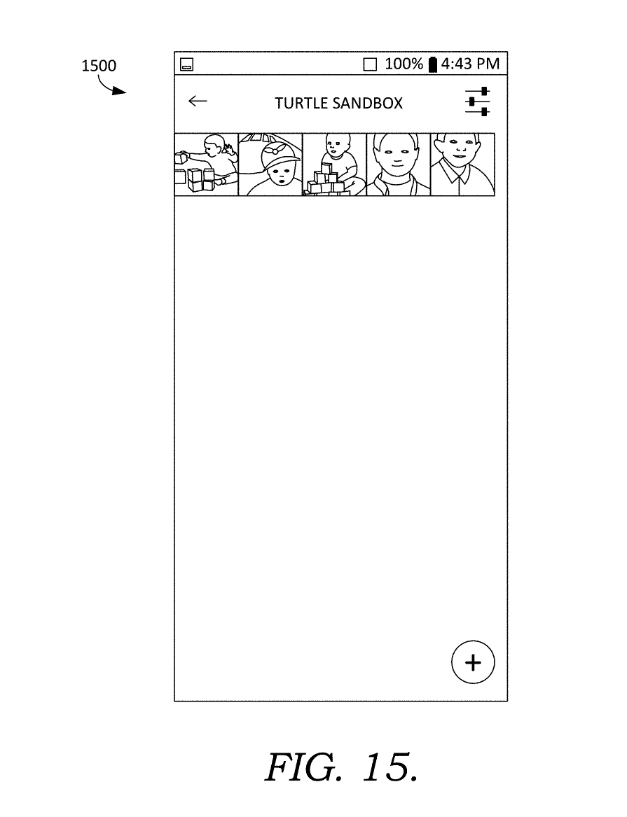

If the user selects the option to add photos from the phone's library 824, the user is provided with a screen 828 displaying the photos on their phone (see FIG. 14, as an example). The user may then select as many photos as desired 830 (see exemplary screen display with photos selected 832), confirm the photos selected 834, and then direct them 836 to be uploaded to the database 838. The product memory screen is then updated and presented with the new photos (see FIG. 15, as an example).

If the user selects an existing photo 826, the user is presented with a preview content screen 840 where they may view any metadata associated with a selected photograph 842 and/or add or update a comment 844 to be associated with the photo and any updates. This information is then also submitted to and uploaded on the web server/database, for instance, in the cloud 846. The product memory screen is then updated and presented to the user.

FIGS. 9 and 9A-9C are schematic diagrams that collectively illustrate an exemplary Product Settings method 900, in accordance with embodiments of the present invention. FIG. 9 shows the entire exemplary method 900. FIGS. 9A-9C each shows a portion of the method 900 of FIG. 9 a bit larger, for ease of viewing. To reconstruct (or “stitch” back together), FIG. 9B is to be placed beneath and to the right of FIG. 9A, and FIG. 9C is to be placed beneath and to the left of FIG. 9A, each of 9B and 9C aligning about half-way down the page on which FIG. 9A is presented.

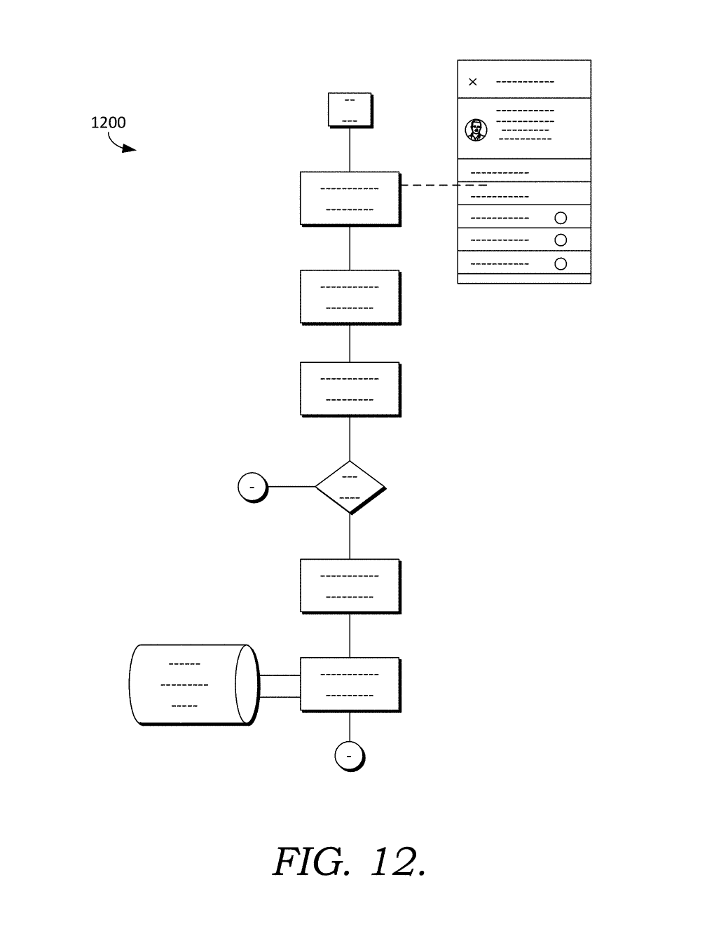

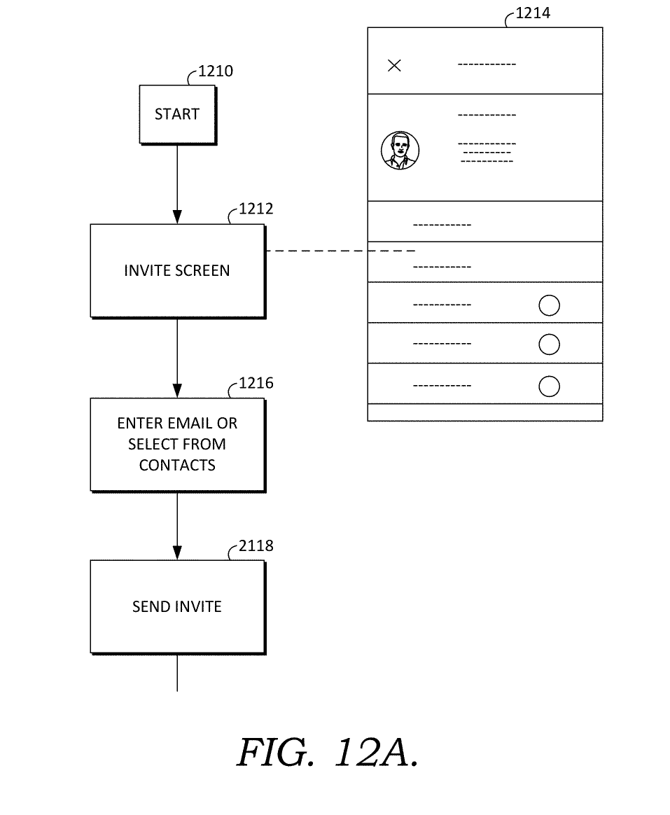

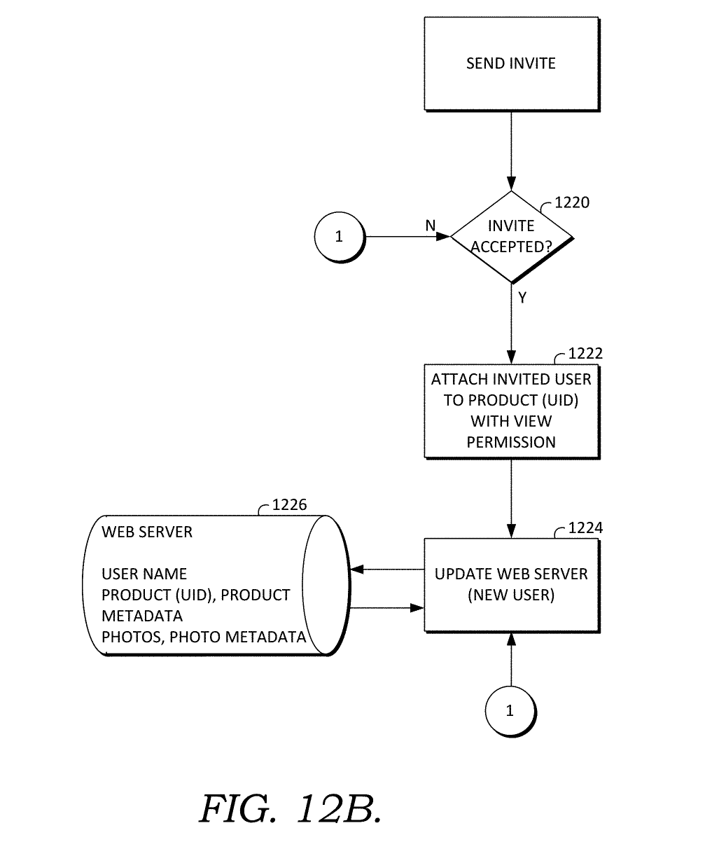

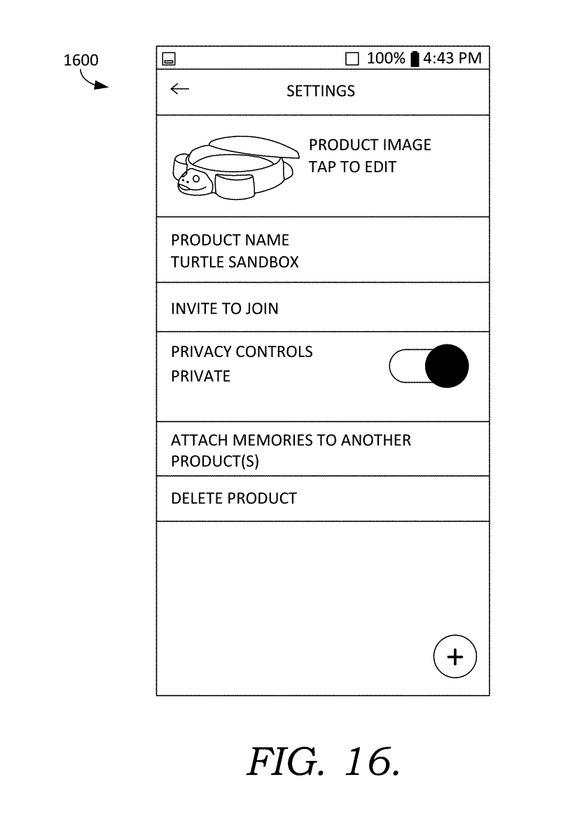

In the initial step, information concerning the product and the user is pulled 910 from the database 912 and displayed on a product settings screen 914 (see FIG. 16, as an example). The screen will either display that no products are attached 916 or that memories are attached to another product 918. The user may then select an action 920 consisting of: going to the memories screen (FIG. 8), going to the invite screen (FIG. 12) to share product memories with others 922, attaching memories to another product 924, setting privacy controls 926, adding or update the product name 928, or deleting the product 930.

If the user selects to attach memories to another product 924, the user is provided with a scan screen and is directed to scan the new product, at which point they are directed to the scan flow chart of FIG. 7. Alternatively, if the user selects to set the privacy controls for the product 926, they select a “public” or “private” indicator 932 and the updated privacy information is transmitted to the server 934. If the user desires to add or update the product name 928, they click on the edit icon and enter the desired text 936, which is then transferred to the server 938. Lastly, if the user selects a “delete product” indicator, an “are you sure” type screen 940 is presented. If “yes, delete” is selected 942, the product is deleted 944 and the server is updated 946. If “cancel” is selected, the user is returned to the product settings screen.

FIG. 10 is a schematic diagram of a flow chart illustrating an exemplary App Settings method 1000, in accordance with embodiments of the present invention. The method begins at 1010. App settings are retrieved from local storage 1012 (e.g., on the phone or other NFC-enabled device) and an app settings screen is presented 1014. An exemplary app setting screen is illustrated as reference numeral 1016. The user may then select 1016 various options to control the functionality of the app. For example, the user may choose if they want the app to be password protected, if they want notifications, or to view the account information. App control settings are configurable and known to those having ordinary skill in the relevant art. Accordingly, the app control settings or potential actions are not further described herein.

FIG. 11 is a schematic diagram of a flow chart illustrating an exemplary Link Products method 1100, in accordance with embodiments of the present invention. The method 1100 begins at 1110. The new UID is attached to the AttachID photos 1112. The database 1116 is updated 1114 and the user is returned to the product settings screen of FIG. 9.

FIGS. 12, 12A and 12B collectively are a schematic diagram of a flow chart illustrating an exemplary Invitation to View method 1200, in accordance with embodiments of the present invention. FIG. 12 shows the entire exemplary method 1200. FIGS. 12A and 12B each shows a portion of the method 1200 of FIG. 12 a bit larger, for ease of viewing. To reconstruct (or “stitch” back together), FIG. 12B is to be placed beneath and to the left of center with respect to FIG. 12A.

The method 1200 begins at 1210. An invite screen is displayed 1212, an exemplary invite screen being shown at reference numeral 1214. The user may then enter an e-mail or phone number of a person to invite or they may select a person or persons from their contacts 1216. After such action, an invite is sent to the individual 1218. If accepted 1220, the invited user is associated with the tag 1222 and the product and information concerning their permission to view the files associated with the tag is uploaded 1224 to the web server 1226.

FIGS. 13-16 are representative screenshots from an app operating in accordance with exemplary embodiments of the present invention. FIG. 13 illustrates an exemplary screenshot 1300 of a main screen showing the products added to the user's app and where a user may add new products, as discussed in connection with FIG. 6. FIG. 14 illustrates an exemplary screenshot 1400 wherein a user selects photos from a library associated with an NFC-enabled device to be associated with a tag in a product, as discussed in connection with FIG. 8. FIG. 15 illustrates and exemplary screenshot 1500 wherein user-selected photographs are presented that have been associated with a tag in a product, as discussed in connection with FIG. 8. Lastly, FIG. 16 illustrates an exemplary screenshot 1600 of a product setting screen, as discussed in connection with FIG. 9.

The digital information that can be associated with the tag is virtually limitless. A user could upload information personal to them (i.e., personal digital media), including but not limited to a personal or group text file, a personal audio file, baby/wedding registry information, save the date/invitation information, and/or links to maps for directions to personal events such as birthdays, and the like. Further, the tag itself may have varied digital information stored in association with local memory associated with the tag.

### Operating Environment

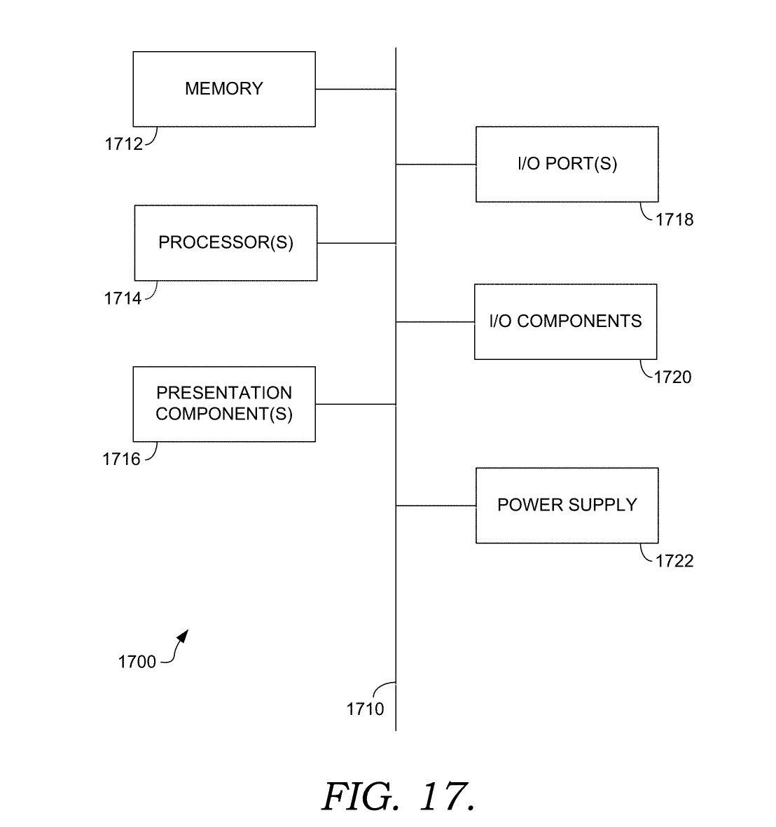

Having described an overview of embodiments of the present invention, an exemplary operating environment in which embodiments of the present invention may be implemented is described below in order to provide a general context for various aspects of the present invention. With reference to FIG. 17, an exemplary operating environment for implementing embodiments of the present invention is shown and designated generally as computing device 1700. The computing device 1700 is but one example of a suitable computing environment and is not intended to suggest any limitation as to the scope of use or functionality of embodiments of the invention. Neither should the computing device 1700 be interpreted as having any dependency or requirement relating to any one component nor any combination of components illustrated.

Embodiments of the invention may be described in the general context of computer code or machine-useable instructions, including computer-useable or computer-executable instructions such as program modules, being executed by a computer or other machine, such as a personal data assistant or other handheld device. Generally, program modules include routines, programs, objects, components, data structures, and the like, and/or refer to code that performs particular tasks or implements particular abstract data types. Embodiments of the invention may be practiced in a variety of system configurations, including, but not limited to, hand-held devices, consumer electronics, general-purpose computers, more specialty computing devices, and the like. Embodiments of the invention may also be practiced in distributed computing environments where tasks are performed by remote-processing devices that are linked through a communications network.

With continued reference to FIG. 17, the computing device 1700 includes a bus 1710 that directly or indirectly couples the following devices: a memory 1712, one or more processors 1714, one or more presentation components 1716, one or more input/output (I/O) ports 1718, one or more I/O components 1720, and an illustrative power supply 1722. The bus 1710 represents what may be one or more busses (such as an address bus, data bus, or combination thereof). Although the various blocks of FIG. 17 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art, and reiterate that the diagram of FIG. 17 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 17 and reference to “computing device.”

The computing device 1700 typically includes a variety of computer-readable media. Computer-readable media may be any available media that is accessible by the computing device 1700 and includes both volatile and nonvolatile media, removable and non-removable media. Computer-readable media comprises computer storage media and communication media; computer storage media excluding signals per se. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 100. Communication media, on the other hand, embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 1712 includes computer-storage media in the form of volatile and/or nonvolatile memory. The memory may be removable, non-removable, or a combination thereof. Exemplary hardware devices include solid-state memory, hard drives, optical-disc drives, and the like. The computing device 1700 includes one or more processors that read data from various entities such as the memory 1712 or the I/O components 1720. The presentation component(s) 1716 present data indications to a user or other device. Exemplary presentation components include a display device, speaker, printing component, vibrating component, and the like.

The I/O ports 1718 allow the computing device 1700 to be logically coupled to other devices including the I/O components 1720, some of which may be built in. Illustrative I/O components include a microphone, joystick, game pad, satellite dish, scanner, printer, wireless device, a controller, such as a stylus, a keyboard and a mouse, a natural user interface (NUI), and the like.

A NUI processes air gestures, voice, or other physiological inputs generated by a user. These inputs may be interpreted, for instance, as words or symbols appearing in programs and/or apps, and the like presented by the computing device 1700. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 100. The computing device 1700 may be equipped with depth cameras, such as, stereoscopic camera systems, infrared camera systems, RGB camera systems, and combinations of these for gesture detection and recognition. Additionally, the computing device 1700 may be equipped with accelerometers or gyroscopes that enable detection of motion. The output of the accelerometers or gyroscopes may be provided to the display of the computing device 1700 to render immersive augmented reality or virtual reality.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices. The computer-useable instructions form an interface to allow a computer to react according to a source of input. The instructions cooperate with other code segments to initiate a variety of tasks in response to data received in conjunction with the source of the received data.

As can be understood, embodiments of the present invention provide systems, methods, and computer-readable storage media for, among other things, using NFC tags associated with physical objects in conjunction with NFC-enabled devices to associate digital content with physical assets. The present invention has been described in relation to particular embodiments, which are intended in all respects to be illustrative rather than restrictive. Alternative embodiments will become apparent to those of ordinary skill in the art to which the present invention pertains without departing from its scope.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A method being performed by one or more computing devices including at least one processor, the method for associating digital content with physical objects using NFC tags and comprising:
receiving digital content to be associated with an NFC tag, the NFC tag being associated with a physical object;
storing the digital content in association with a unique identifier associated with the NFC tag in an online environment;
receiving an indication that the NFC tag has been read by an NFC reader associated with a user device; and
providing the digital content for presentation in association with the user device.

2. The method of claim 1, wherein the physical object is associated with a particular event or occasion, and wherein the received digital content is related to the particular event or occasion.

3. The method of claim 2, wherein the physical object is one of a greeting card, an ornament, a knick-knack, or a gift associated with the particular event or occasion.

4. The method of claim 1, wherein the digital content stored in association with the NFC tag is one of a photo, a video, an audio file, a text file, a data file, and a hyperlink.

5. The method of claim 1, wherein receiving the digital content to be associated with an NFC tag comprises receiving personalized digital content from a purchaser of the physical object.

6. The method of claim 1, further comprising determining that at least one of the NFC reader and the associated user device has permission to experience the digital content before providing the digital content for presentation in association with the user device.

7. The method of claim 1, further comprising:
receiving additional digital content to be associated with the NFC tag; and
updating the digital content stored in association with the unique identifier associated with the NFC tag to include the additional digital content.

8. The method of claim 1, further comprising:
receiving additional digital content to be associated with the NFC tag; and
overriding the digital content stored in association with the unique identifier associated with the NFC tag with the additional digital content.

9. A computerized system for associating digital content with physical objects using NFC tags, the system comprising:
a processor; and
a non-transitory computer storage medium storing computer-useable instructions that, when used by the processor, cause the processor to:
receive digital content to be associated with an NFC tag, the NFC tag being associated with a physical object;
store the digital content in association with a unique identifier associated with the NFC tag in an online environment;
receive an indication that the NFC tag has been read by an NFC reader associated with a user device;
determine that at least one of the NFC reader and the associated user device has permission to experience the digital content; and
provide the digital content for presentation in association with the user device.

10. The computerized system of claim 9, wherein the physical object is associated with a particular event or occasion, and wherein the received digital content is related to the particular event or occasion.

11. The computerized system of claim 10, wherein the physical object is one of a greeting card, an ornament, a knick-knack, or a gift associated with the particular event or occasion.

12. The computerized system of claim 9, wherein the digital content stored in association with the NFC tag is one of a photo, a video, an audio file, a text file, a data file, and a hyperlink.

13. The computerized system of claim 9, wherein the digital content is personalized digital content from a purchaser of the physical object.

14. The computerized system of claim 9, wherein the processor is further caused to:
receive additional digital content to be associated with the NFC tag; and
update the digital content stored in association with the unique identifier associated with the NFC tag to include the additional digital content.

15. The computerized system of claim 9, wherein the processor is further caused to:
receive additional digital content to be associated with the NFC tag; and
override the digital content stored in association with the unique identifier associated with the NFC tag with the additional digital content.

16. One or more computer-readable storage media storing computer-useable instructions that, when used by one or more computing devices, cause the one or more computing devices to perform a method for associating digital content with physical objects using NFC tags, the method comprising:
receiving digital content to be associated with an NFC tag, the NFC tag being associated with a physical object;
storing the digital content in association with a unique identifier associated with the NFC tag in an online environment;
receiving an indication that the NFC tag has been read by an NFC reader associated with a user device;
determining that at least one of the NFC reader and the associated user device has permission to experience the digital content before providing the digital content for presentation in association with the user device;
providing the digital content for presentation in association with the user device;
receiving additional digital content to be associated with the NFC tag; and
updating or overriding the digital content stored in association with the unique identifier associated with the NFC tag with the additional digital content.

17. The one or more computer-readable storage media of claim 16, wherein the physical object is associated with a particular event or occasion, and wherein at least one of the digital content and the additional digital content is related to the particular event or occasion.

18. The one or more computer-readable storage media of claim 17, wherein the physical object is one of a greeting card, an ornament, a knick-knack, or a gift associated with the particular event or occasion.

19. The one or more computer-readable storage media of claim 16, wherein at least one of the digital content and the additional digital content includes one or more of a photo, a video, an audio file, a text file, a data file, and a hyperlink.

20. The one or more computer-readable storage media of claim 16, wherein at least one of the digital content and the additional digital content is personalized content from a purchaser of the physical object.
